(19) United States
(12) Patent Application Publication
(10) Pub. No.: US 2008/0095130 A1
(43) Pub. Date: Apr. 24, 2008

(54) SYSTEM AND METHOD OF NETWORK IDENTIFIER POLLING

(76) Inventors: Ajay Puri, Brampton (CA); Arun Munje, Kanata (CA); Ahmad Daud Lateef, Kanata (CA); Shahid Chaudry, Ottawa (CA); Robbie Maurice, Waterloo (CA)

Correspondence Address: SMART & BIGGAR;P.O. BOX 2999, STATION D, 900-55 METCALFE STREET, OTTAWA, ON, K1P5Y6, US

(21) Appl. No.: 11/551,960

(22) Filed: Oct. 23, 2006

(51) Int. Cl. H04B 7/216

(52) U.S. Cl. 370/342

(57) ABSTRACT

A system and method of polling for a network identifier value is provided. Within a wireless device, a transport layer or application layer polls a radio layer for a network identifier value on a first basis. However, upon occurrence of an event of a predefined type, the transport layer polls for the network identifier value on a more frequent basis than the first basis. At some later time, the transport layer polls for the network identifier value on the first basis. Accordingly, the transport layer achieves a balance of polling frequently at certain times so as to obtain an accurate network identifier value while minimizing undue polling at other times so as to conserve battery power.

### FIELD OF THE APPLICATION

The application relates to wireless devices, and more particularly to polling for network identifier values.

### BACKGROUND

In a wireless system, a wireless device typically has a radio layer, a transport layer, and an application layer. The radio layer includes a protocol stack and is typically aware of the network identifier of the zone in which the wireless device resides. In a CDMA (code division multiple access) system, the network identifier is a SID (system identifier). In a GPRS system, the network identifier includes both an mcc (mobile country code) and an mnc (mobile network code).

### BRIEF DESCRIPTION OF THE DRAWINGS

Embodiments will now be described with reference to the attached drawings in which:

FIG. 1 is a schematic oft an example wireless device;

FIG. 2 is a flowchart of an example method of polling for a network identifier in which an event triggers polling an a more frequent basis;

FIG. 3 is a flowchart of an example method of initiating a registration based on an observed network identifier change;

FIG. 4 is a flowchart of example events triggering polling on the more frequent basis;

FIG. 5 is a flowchart of an example method of polling in a manner that is dependent upon the event that has occurred;

FIG. 6 is a flowchart of an example method of polling on the more frequent basis; and

FIGS. 7A through 7D are graphs providing examples of the polling on the more frequent basis.

### DETAILED DESCRIPTION OF THE PREFERRED EMBODIMENTS

Unfortunately, when there has been a change in the network identifier value, the radio layer does not always inform the transport layer. Therefore, the transport layer periodically polls the radio layer for the network identifier value. A high frequency of polls allows the transport layer to maintain an accurate network identifier value. However, polling the radio layer for network identifier values at a high frequency consumes battery power of the wireless device.

According to a broad aspect there is provided a method comprising: polling for a network identifier value on a first basis; upon occurrence of an event of a predefined type, polling for the network identifier value on a more frequent basis than the first basis; and at some later time, polling for the network identifier value on the first basis.

According to another broad aspect there is provided a computer readable medium having computer executable instructions stored thereon for execution on a processor so as to implement the method summarized above.

According to a broad aspect there is provided a wireless device comprising: a wireless access radio adapted to communicate with a wireless network; a radio function adapted to facilitate communication over the wireless access radio; a transport function and an application function, one of the transport function and application function comprising a network identifier polling function, the network identifier polling function being adapted to: a) poll the radio function for a network identifier value on a first basis; b) upon occurrence of an event of a predefined type, poll the radio function for the network identifier value on a more frequent basis than the first basis, and c) at some later time, poll the radio function for the network identifier value on the first basis.

### Wireless Device

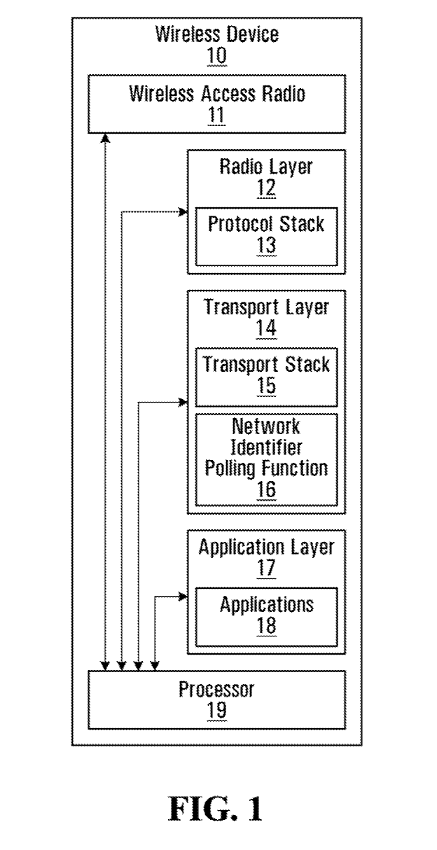

Referring now to FIG. 1, shown is a schematic of an example wireless device 10. The wireless device 10 has a processor 19 coupled to a wireless access radio 11, a radio layer 12, a transport layer 14, and an application layer 17. The radio layer 12 has a protocol stack 13, while the application layer 17 has a plurality of applications 18. The transport layer 14 has a transport stack 15 and a network identifier polling function 16. The wireless device 10 may have other components, but they are not shown for sake of simplicity.

In FIG. 1, the network identifier polling function 16 is shown as part of the transport layer 14. In other embodiments, the network identifier polling function is in the application layer. In some embodiments, the application wraps the transport stack so all interaction between the radio and transport stack goes through the application layer (Radio<->App<->Transport). In this case, since the notifications of network identifier change are expected to come from the application layer, it is the application layer that is doing the polling.

In operation, the wireless device 10 is adapted to communicate with a wireless network (not shown) via the wireless access radio 11. Such communication may be in respect of one or more of the applications 18 of the application layer 17. The radio layer 12 uses the protocol stack 13 to facilitate protocol communications over the wireless access radio 11. The radio layer 12 is aware of the network identifier value of the zone in which the wireless device 10 resides. The transport layer 14 polls for network identifier values from the radio layer 12. In some implementations, if there has been a change in the network identifier value, then the transport layer 14 initiates a registration to ensure that the wireless device 10 is “always-on”. Always-on connectivity may be important to one or more of the applications 18 of the application layer 17.

According to an embodiment of the application, the network identifier polling function 16 implements a polling scheme whereby the frequency of polling is dependent upon one or more predefined events. The transport layer 14 polls for a network identifier value on a first basis; however, upon occurrence of an event of a predefined type, the transport layer 14 polls for the network identifier value on a more frequent basis than the first basis. The higher frequency of polls allows for any changes to the network identifier value to be detected more quickly than if a slower frequency of polling was used. At some later time, the transport layer 14 resumes polling on the first basis so as to conserve battery power,.

There are many possibilities for the polling on the first basis and for the polling on the more frequent basis. The polling on the first basis involves any appropriate polling scheme such that polling is performed at a relatively low frequency or range of frequencies so as to conserve battery power. The polling on the more frequent basis involves any appropriate polling scheme such that polling is performed on a more frequent basis than the polling on the first basis. Example implementation details of the polling schemes are provided with reference to the subsequent Figures.

In the illustrated example, the network identifier polling function 16 is implemented as software and is executed on the processor 19. However, more generally, the network identifier polling function 16 may be implemented as software, hardware, firmware, or any appropriate combination thereof.

The network identifier being polled is implementation-specific and typically depends on the type of wireless system in which the wireless device 10 resides. There are many possibilities for the wireless system. In some implementations, the wireless device 10 is in a CDMA (Code Division Multiple Access) system and the network identifier is a SID (system identifier). For CDMA systems, always-on connectivity involves PPP (point-to-point protocol) connectivity. In some implementations, the wireless system includes an EVDO (Evolution Data Optimised) network. EVDO is an overly to CDMA 1X. From data connectivity point of view, EVDO and CDMA share the same PCF (Packet Control Function) box on the network side, which the wireless device connects to in order to establish a new connection. PCF is sitting behind the PDSN (Packet Data Serving Node) in network topology. In some network implementations, EVDO overlay goes further than CDMA signal so there is coverage by EVDO signals but not CDMA signals. For such areas, monitoring network identifier change of EVDO network will allow reestablishment of service if EVDO network identifier changes. The network identifier for EVDO includes a Sector ID and/or a Color Code.

In other implementations, the wireless device 10 is in a GPRS (General Packet Radio Service) system and the network identifier includes both an mcc (mobile country code) and mnc (mobile network code). For GPRS systems, always-on connectivity involves PDP (Packet Data Protocol) connectivity. In some implementations, the wireless system includes an EDGE (Evolution Data Optimised) network. Implementations with EDGE follow similar principles discussed above for EVDO, as EDGE is an enhancement to GPRS, which is an overlay to GSM.

In other implementations, the wireless device 10 is in a UMTS (Universal Mobile Telecommunications System) and the network identifier includes both an mcc and an mnc. Other wireless systems and associated network identifiers are possible. More generally, embodiments of the application are applicable to any wireless system whereby the radio layer does not provide network identification change notifications to the transport or application layer.

It is to be understood that the wireless device 10 is shown with a very specific arrangement of components and is for example purposes only. Different arrangements of components are possible. The wireless device 10 is shown with “layers” such as the radio layer 12 for implementing various functionality; however, more generally, any “function”, whether layered or not layered, may be implemented. Furthermore, components that are shown separately may be combined as a single component. For example, in some implementations, the network identifier polling function 16 is combined with the transport stack 15 as a single component. Other combinations are possible.

### Method in a Wireless Device

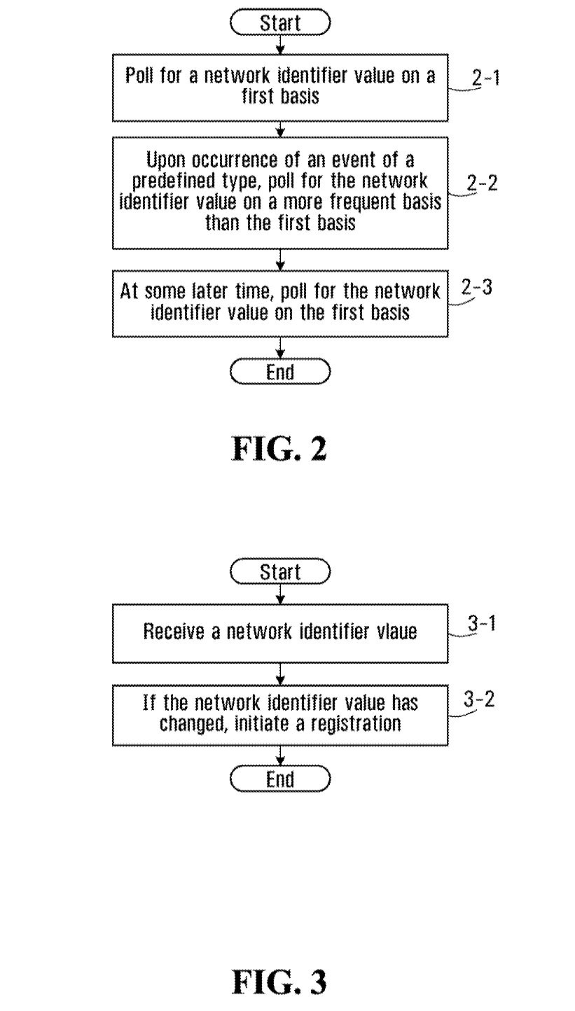

Referring now to FIGS. 2 through 6, shown are flowcharts of an example method of polling for a network identifier in which an event triggers polling on a more frequent basis. This method may be implemented in a wireless device, for example by the network identifier polling function 16 of the transport layer 14 shown in FIG. 1.

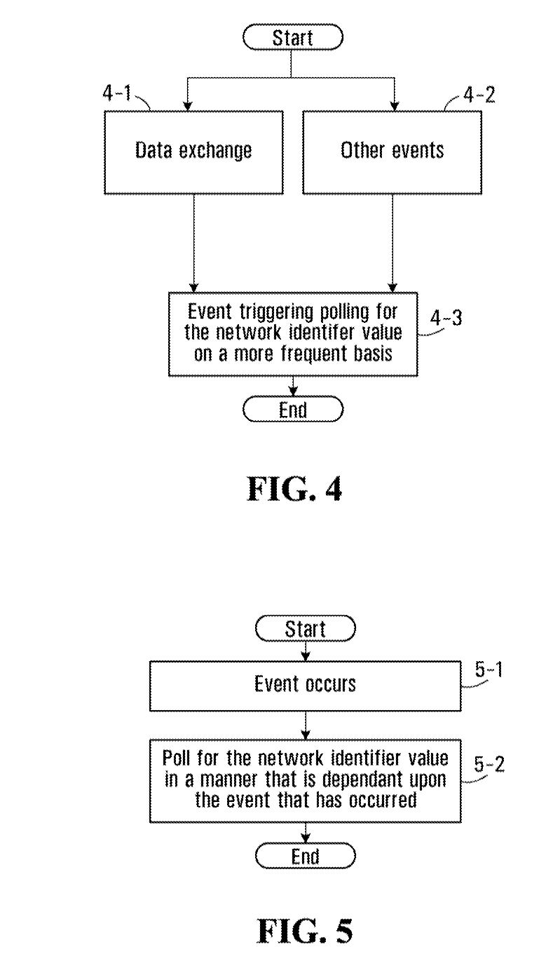

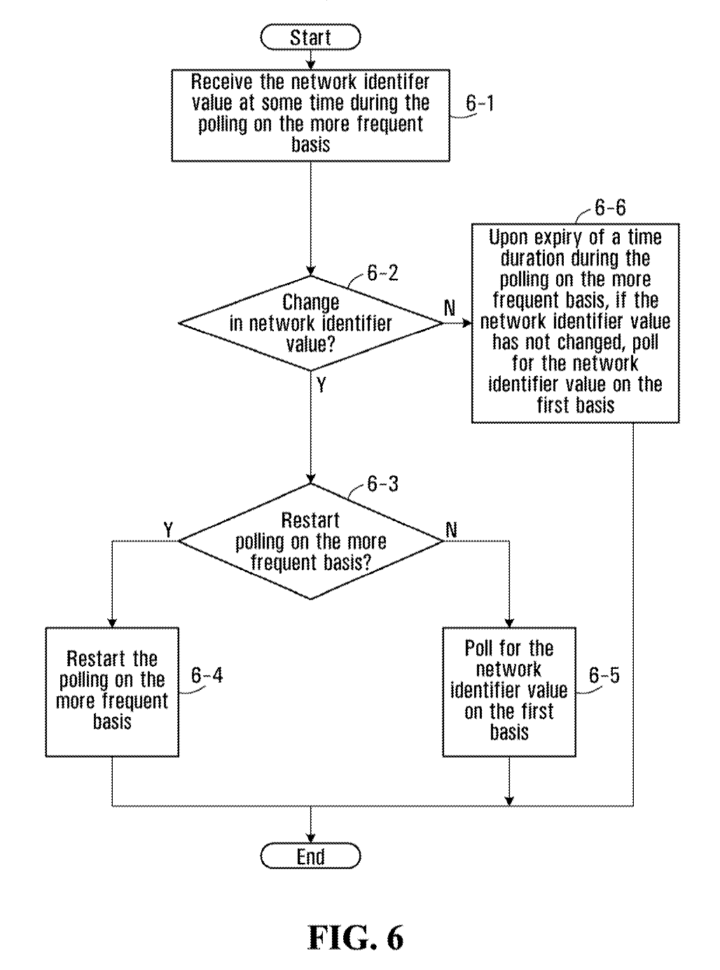

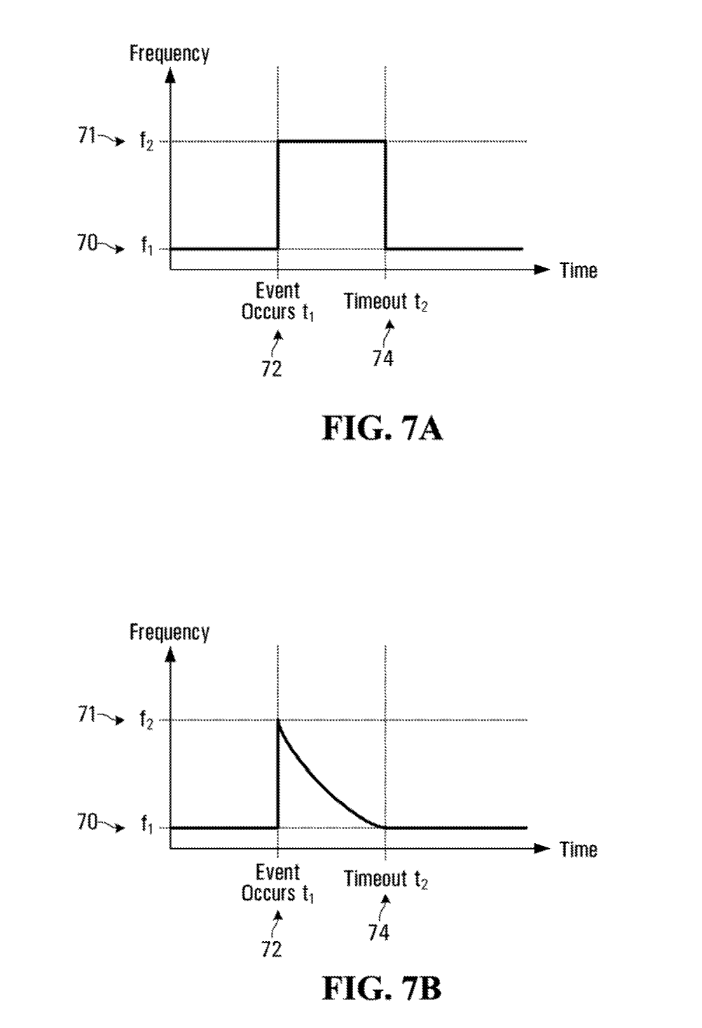

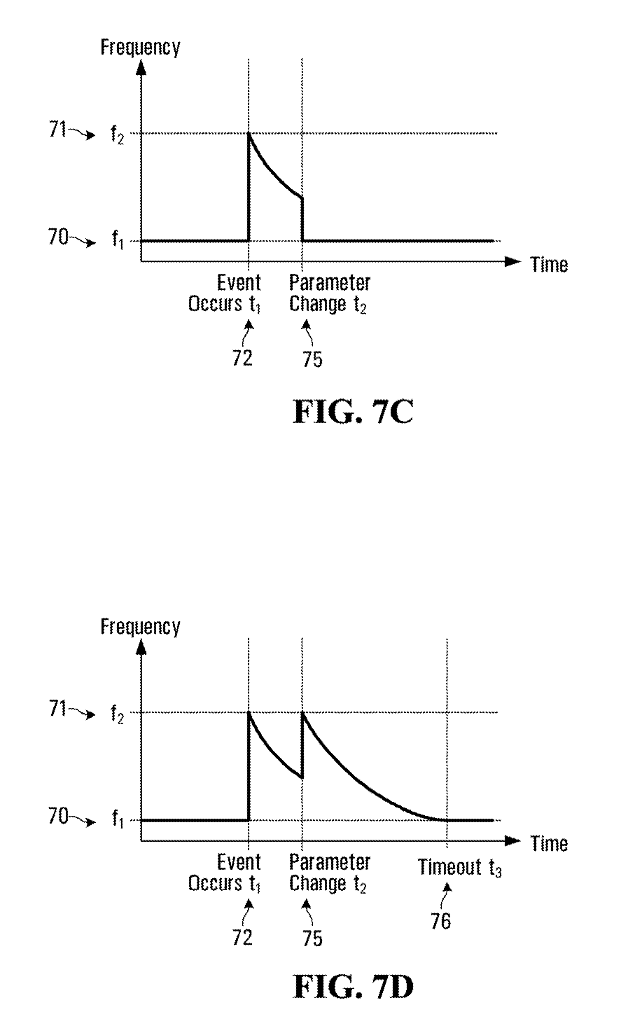

Referring first to FIG. 2, at step 2-1, the transport layer polls for a network identifier value on a first basis. At step 2-2, upon occurrence of an event of a predefined type, the transport layer polls for the network identifier value on a more frequent basis than the first basis. Further details of the event are provided below with reference to FIGS. 4 and 5; further details of the polling on the more frequent basis are provided below with reference to FIGS. 6 and 7. At step 2-3, at some later time, the transport layer polls for the network identifier value on the first basis.

In some implementations, if the transport layer receives the network identifier value from the radio layer and observes that there has been a network identifier change, then the transport layer initiates a registration. Referring now to FIG. 3, shown is a flowchart of an example method of initiating a registration based on an observed network identifier change. At step 3-1, the transport layer receives a network identifier value. At step 3-2, if the network identifier value has changed, then the transport layer initiates a registration so as to maintain always-on connectivity.

There are many implementation specific possibilities for the event that that is predetermined to trigger polling on the more frequent basis. In some implementations, if it is known that changes to a network identifier value are more likely upon occurrence of a particular event, then the particular event is predetermined to trigger the higher frequency of polling. In other implementations, if it is known that having an accurate network identifier value is more important upon occurrence of a particular event, then the particular event is predetermined to trigger the higher frequency of polling. Referring now to FIG. 4, shown is a flowchart of example events triggering polling on the more frequent basis. If there is a data exchange at step 4-1, then at step 4-3 there has been an event triggering polling for the network identifier value on a more frequent basis. Other events are possible as indicated in step 4-2. Suitable events are those that may occur when the network identifier changes, the logic being that if such an event has occurred, then maybe the network identifier has changed so it is a good time to check. Since “always-on” connectivity is relevant when sending/receiving data, it is a more relevant event to check for network identifier changes instead of a user tapping a button for example.

In some implementations, the polling on the more frequent basis is performed in a manner that is dependent upon the event that has occurred. Referring now to FIG. 5, shown is a flowchart of an example method of polling in a manner that is dependent upon the event that has occurred. At step 5-1, an event triggering polling on the more frequent basis occurs. Example events that may trigger the polling on the more frequent basis have been provided above and are therefore not repeated here. At step 5-2, the transport layer polls for the network identifier value in a manner that is dependent upon the event that has occurred.

There are many ways that the polling on the more frequent basis can be dependent upon the event that has occurred. In some implementations, the transport layer polls for the network identifier value for a time duration that is dependent upon the event that has occurred. In other implementations, the transport layer polls for the network identifier value with a constant frequency that is dependent upon the event that has occurred. In other implementations, the transport layer polls for the network identifier value with a variable frequency that is dependent upon the event that has occurred. Other implementations are possible.

Referring now to FIG. 6, shown is a flowchart of an example method of polling on the more frequent basis. If at step 6-1 the transport layer receives the network identifier value at some time during the polling on the more frequent basis, then the transport layer determines at step 6-2 whether or not the network identifier value has changed. In some implementations, if the network identifier value has changed, then the transport layer initiates a registration. At step 6-2 the transport layer determines whether or not it should restart polling on the more frequent basis. Restarting the polling on the more frequent basis may lengthen the time during which polling on the more frequent basis is performed. It may also change the frequency of polling in the event that the polling on the more frequent basis is implemented with a variable frequency of polling. An example is provided below with reference to FIG. 7D. If the transport layer determines that it should restart polling on the more frequent basis, then at step 6-4 the transport layer restarts the polling on the more frequent basis. Otherwise, at step 6-5 the transport layer polls for the network identifier value on the first basis. However, if there has been no change in the network identifier value upon expiry of a time duration during the polling on the more frequent basis, then at step 6-6 the transport layer polls for the network identifier value on the first basis. This is known as a timeout.

There are many ways that the transport layer may determine whether or not the polling on the more frequent basis should be restarted. In some implementations, the transport layer makes this determination based on user input. For example, the user of the wireless device can input their preference for PPP connectivity versus preserving battery power. If the user prefers to conserve battery power, then the transport layer does not restart the polling on the more frequent basis. However, if the user has a stronger preference for PPP connectivity, then the transport layer restarts the polling on the more frequent basis. In other implementations, the transport layer determines whether or not to restart polling based on a hard-coded setting that cannot be manipulated by the user. Other implementations are possible.

In some implementations, the transport layer polls for the network identifier only if the wireless access radio of the wireless device is on. If the wire less access radio is not on, then PPP connectivity is no longer possible. Therefore, there is little or no use in polling for the network identifier when the wireless access radio is off.

### Polling Examples

Referring now to FIGS. 7A through 7C, shown are graphs providing examples of the polling by the transport layer on the more frequent basis. Each graph compares frequency of polling versus time and illustrates example results that may be achieved by various implementations of the method described above with reference to FIGS. 2 through 6. It is to be understood that these graphs are very specific and are for example purposes only. In each example, references to an event triggering the polling on the more frequent basis are made. References to observing network identifier changes, and timeouts while waiting for a change in a network identifier are also made. Example details of these topics have been provided above and therefore are not repeated here.

Referring first to FIG. 7A, the polling frequency starts at f₁ 70 and remains constant until an event occurs at t₁ 72. Upon the event at t₁ 72, the frequency of polling increases to f₂ 71. The frequency of polling remains constant at f₂ 71 until a timeout occurs at t₂ 74 at which time the frequency of polling decreases back down to f₁ 70.

In the illustrated example, the polling for the network identifier value on the more frequent basis, f₂ 71, is done so with a constant frequency of polling. However, in other implementations, a variable frequency of polling is accomplished. FIG. 7B provides an example of this.

Referring now to FIG. 7B, the polling frequency starts at f₁ 70 and remains constant until an event occurs at t₁ 72. Upon the event at t₁ 72, the frequency of polling increases to f₂ 71. The frequency of polling decreases in a non-linear manner until a timeout at t₂ 74. At this time, the frequency of polling has decreased to f₁ 70.

In the illustrated example, the decrease in frequency is non-linear. However, in other implementations, the decrease in frequency is linear. More generally, the decrease in frequency may be linear, non-linear, or an appropriate combination thereof (i.e. portions that are linear and portions that are non-linear).

In the illustrated example, the frequency of polling decreases to f₁ 70 at the same time as the timeout at t₂ 74. However, in other implementations, the frequency of polling is greater than f₁ 70 at the timeout at t₂ 74. In some implementations, the frequency of polling decreases to f₁ 70 upon the timeout at t₂ 74.

In the examples provided above with reference to FIGS. 7A and 7B, it is assumed that there is a timeout at t₂ 74, as there is no observed change in network identifier value. FIGS. 7C and 7D provide examples of the situation in which polling frequency is dependent upon observing an additional a change in network identifier value.

Referring now to FIG. 7C, the polling frequency starts at f₁ 70 and remains constant until an event occurs at t₁ 72. Upon the event at t₁ 72, the frequency of polling increases to f₂ 71. The frequency of polling decreases in a non-linear manner until a parameter change is observed at t₂ 75. At this time, the frequency of polling decreases to f₁ 70.

In the illustrated example, the observing of a network identifier change prompts the polling on the more frequent basis to end. However, in other implementations, the polling on the more frequent basis is restarted. An example of this is provided below with reference to FIG. 7D.

Referring now to FIG. 7D, the polling frequency starts at f₁ 70 and remains constant until an event occurs at t₁ 72. Upon the event at t₁ 72, the frequency of polling increases to f₂ 71. The frequency of polling decreases in a non-linear manner until a parameter change is observed at t₂ 75. At this time, the frequency of polling increases back to f₁ 71. The polling on the more frequent basis is restarted. The frequency of polling decreases in a non-linear manner until a timeout at t₃ 76.

In the illustrated example, the timeout at t₃ 76 occurs because the transport layer does not observe another network identifier value change. In some implementations, if another network identifier value change is observed before t₃ 76, then the polling on the more frequent basis is restarted a second time. In some implementations, the polling on the more frequent can be restarted many times so long as network identifier changes are observed before a timeout period.

With reference to FIGS. 7A through 7D, there are many implementation specific values for f₁ 70 and f₂ 71. In some implementations, the transport layer determines f₁ 70 and f₂ 71 based on a time period between polls. The polls during the first basis are separated by a first time period while the polls during the more frequent basis are separated by a variable time period between polls, the variable time period between polls starting at a minimum value and being incremented with each poll unless the variable time period reaches a maximum value. In some implementations, the first time period is equal to the maximum value of the variable time period during the polling on the more frequent basis. In specific implementations, the minimum value is 5 seconds and the maximum value is 15 minutes. Other implementations are possible.

Numerous modifications and variations of the present application are possible in light of the above teachings. It is therefore to be understood that within the scope of the appended claims, the application may be practised otherwise than as specifically described herein.

We claim:

1. A method comprising:
polling for a network identifier value on a first basis;
upon occurrence of an event of a predefined type, polling for the network identifier value on a more frequent basis than the first basis; and
at some later time, polling for the network identifier value on the first basis.

2. The method of claim 1 wherein:
for at least one event type used to trigger more frequent polling, it is known that changes to a network identifier value are more likely upon occurrence of an event of that event type; and/or
for at least one event type used to trigger more frequent polling, it is known that having an accurate network identifier value is more important upon occurrence of an event of that event type.

3. The method of claim 1 further comprising:
receiving the network identifier value; and
if the network identifier value has changed, initiating a registration.

4. The method of claim 1 wherein the predefined type of event comprises a data exchange.

5. The method of claim 1 further comprising:
receiving the network identifier value at some time during the polling on the more frequent basis;
determining if the network identifier value has changed; and
if the network identifier value has changed, polling for the network identifier value on the first basis.

6. The method of claim 1 further comprising:
receiving the network identifier value at some time during the polling on the more frequent basis;
determining if the network identifier value has changed; and
if the network identifier value has changed, restarting the polling for the network identifier value on the more frequent basis.

7. The method of claim 1 further comprising:
upon expiry of a time duration during the polling on the more frequent basis, if the network identifier value has not changed, polling for the network identifier value on the first basis.

8. The method of claim 1 wherein polling for the network identifier value on the more frequent basis comprises:
polling for the network identifier value with a constant frequency of polling.

9. The method of claim 1 wherein polling for the network identifier value on the more frequent basis comprises:
polling for the network identifier value with a variable frequency of polling.

10. The method of claim 9 wherein polling for the network identifier value with the variable frequency of polling comprises:
polling for the network identifier value with a frequency that decreases over time.

11. The method of claim 10 wherein polling for the network identifier value with the frequency that decreases over time comprises at least one of:
polling for the network identifier value with a frequency that decreases linearly over time; and
polling for the network identifier value with a frequency that decreases non-linearly over time.

12. The method of claim 10 wherein polling for the network identifier value with the frequency that decreases over time comprises:
polling for the network identifier value with a variable time period between polls, the variable time period between polls starting at a minimum value and being incremented with each poll unless the variable time period reaches a maximum value.

13. The method of claim 12 wherein polls during the first basis are separated by a first time period, the first time period being equal to the maximum value of the time period during the polling on the more frequent basis.

14. The method of claim 12 wherein the minimum value is 5 seconds and the maximum value is 15 minutes.

15. The method of claim 1 wherein polling for the network identifier value on the more frequent basis comprises:
polling for the network identifier value in a manner that is dependent upon the event that has occurred.

16. The method of claim 15 wherein polling for the network identifier value in the manner that is dependent upon the event that has occurred comprises at least one of:
polling for the network identifier value for a time duration that is dependent upon the event that has occurred;
polling for the network identifier value with a constant frequency that is dependent upon the event that has occurred; and
polling for the network identifier value with a variable frequency that is dependent upon the event that has occurred.

17. The method of claim 1 wherein polling for the network identifier occurs only if a wireless access radio is on.

18. The method of claim 1 wherein the network identifier value comprises at least one of:
a SID (System Identifier) value;
both an mcc (mobile country code) value and an mnc (mobile network code) value, and
a Sector ID value or a Color Code value.

19. A computer readable medium having computer executable instructions stored thereon for execution on a processor so as to implement the method of claim 1.

20. A wireless device comprising:
a wireless access radio adapted to communicate with a wireless network;
a radio function adapted to facilitate communication over the wireless access radio;
a transport function and an application function, one of the transport function and application function comprising a network identifier polling function, the network identifier polling function being adapted to:
a) poll the radio function for a network identifier value on a first basis;
b) upon occurrence of an event of a predefined type, poll the radio function for the network identifier value on a more frequent basis than the first basis; and
c) at some later time, poll the radio function for the network identifier value on the first basis.
